(19) United States
(12) Patent Application Publication
(10) Pub. No.: US 2014/0267452 A1
(43) Pub. Date: Sep. 18, 2014

(54) DISPLAY CONTROL CIRCUIT, ELECTRO-OPTICAL DEVICE AND ELECTRONIC APPARATUS

(71) Applicant: Seiko Epson Corporation, Tokyo (JP)

(72) Inventors: Junichi Wakabayashi, Matsumoto-shi (JP); Hiroyuki Hosaka, Matsumoto-shi (JP); Hiroaki Ichimura, Matsumoto-shi (JP)

(73) Assignee: Seiko Epson Corporation, Tokyo (JP)

(21) Appl. No.: 14/198,342

(22) Filed: Mar. 5, 2014

(30) Foreign Application Priority Data
Mar. 13, 2013 (JP) 2013-050654

(51) Int. Cl. G09G 3/36

(52) U.S. Cl. CPC G09G 3/3607
USPC 345/690; 345/88

(57) ABSTRACT

A signal generation circuit of an electro-optical device includes a generation unit that generates correction data corresponding to each pixel circuit based on input image data, a specification unit that, when a value which denotes a difference of two pieces of correction data corresponding to two pixel circuits adjacent to each other is equal to or greater than a predetermined threshold, specifies the two pixel circuits as boundary pixel circuits, an updating unit that generates updated correction data by modifying each value of a predetermined number of pieces of correction data corresponding to a predetermined number of pixel circuits including at least one of the boundary pixel circuits so as to be a value between two values indicated by the two pieces of correction data corresponding to the boundary pixel circuits.

### BACKGROUND

1. Technical Field

The present invention relates to a display control circuit, an electro-optical device and an electronic apparatus.

2. Related Art

A liquid crystal display device is known as an example of an electro-optical device that includes an electro-optical element in which an optical characteristic is changed by electric energy. The liquid crystal display device includes a plurality of data lines and a plurality of scan lines, and includes a plurality of pixel circuits each of which is installed in an intersection between the data line and the scan line. The pixel circuit includes a selection transistor, an electro-optical element such as a liquid crystal element. An ON state or an OFF state of the selection transistor is controlled in response to a scan signal supplied through the scan line. When the selection transistor is in the ON state, an image signal supplied through the data line is applied to the liquid crystal element, and when the selection transistor is in the OFF state, a voltage of the image signal is retained in the liquid crystal element. That is, between time when the image signal is first written to the pixel circuit and time when the image signal is secondly written to the pixel circuit, the voltage of the first written image signal is retained in the liquid crystal element, and a transmittance rate of the liquid crystal element is controlled in response to the voltage of the image signal. In driving of the electro-optical device, the plurality of scan lines are sequentially selected, and the image signal is written to the pixel circuit corresponding to the selected scan line through the data line. For this reason, the voltage of the data line changes for each horizontal scan period.

However, the data line and the liquid crystal element are capacitively coupled by a stray capacitance. For this reason, when the voltage of the data line is varied, during a period between the time when the image signal is first written to the pixel circuit corresponding to a certain scan line and the time when the image signal is secondly written to the pixel circuit, the voltage of the image signal retained in the liquid crystal element is varied by a capacitance coupling. As a result, a quality of a display image is degraded. Particularly, in the liquid crystal display device, a polarity inversion driving is employed which inverts a polarity of the image signal with a reference level serving as a center during a predetermined period (for example, one field). For this reason, the voltage of the data line is greatly varied, and a phenomenon referred to as so-called vertical crosstalk occurs.

So, in order to suppress the vertical crosstalk, image data of an amount of one unit period is stored in a memory, the vertical crosstalk is corrected based on the image data of the amount of one unit period stored in the memory, and a technology regarding a so-called vertical crosstalk correction is known (for example, JP-A-2000-330093 and Japanese Patent No. 3869464).

In addition, based on both the image data in one unit period and the image data in a different unit period following the one unit period, a technology for performing a vertical crosstalk correction during the different unit period is known (for example, Japanese Patent No. 4816031).

Based on image data supplied during one unit period, a vertical crosstalk correction is performed during a different unit period following the one unit period. That is, the vertical crosstalk correction is processed on the premise that the same images are displayed during the one unit period and the different unit period following the one unit period.

For this reason, if the vertical crosstalk correction is performed, when images different from each other are displayed during the one unit period and the different unit period, for example, when the image which is displayed is a moving image, the vertical crosstalk correction with respect to a portion where the vertical crosstalk correction is unnecessary to be performed in the displayed image, is performed. Conversely, a situation occurs in which the vertical crosstalk correction is not performed in a portion where the vertical crosstalk correction is necessary to be performed in the displayed image is not performed.

At this time, among the displayed images, between a portion where the vertical crosstalk correction unnecessary to be performed is performed and a peripheral portion thereof, and between a portion where the vertical crosstalk correction necessary to be performed is not performed and a peripheral portion thereof, a display gradation is rapidly changed. Then, as the result of the change of such display gradation being visually recognized, there is a problem that a display quality is decreased.

### SUMMARY

An advantage of some aspects of the invention is that a decrease of the display quality is minimized and the vertical crosstalk is suppressed, even when images different from each other are displayed such as a moving image during two consecutive unit periods.

According to an aspect of the invention, there is provided a display control circuit that is provided in an electro-optical device which includes a scan line; a plurality of data lines that include a first data line and a second data line adjacent to the first data line; a plurality of pixel circuits that include a first pixel circuit installed so as to correspond to the scan line and the first data line, and a second pixel circuit installed so as to correspond to the scan line and the second data line; and a driving unit that, when image data is supplied, supplies an image signal generated based on the image data, through the data line, to a pixel circuit installed so as to correspond to the data line, the display control circuit supplying the driving unit with the image data, the display control circuit includes, a generation unit that, based on input image data supplied only for a unit time from the past to the present, generates a plurality of pieces of correction data which include a first correction data corresponding to an integration value which is obtained by integrating a voltage of the image signal supplied to the first data line only for the unit time from the past to the present, and a second correction data corresponding to an integration value which is obtained by integrating the voltage of the image signal supplied to the second data line only for the unit time from the past to the present; an updating unit that, when a correction difference value which denotes a difference between the first correction data and the second correction data is equal to or greater than a predetermined threshold, updates the plurality of pieces of correction data by modifying at least one value of a value indicated by the first correction data and a value indicated by the second correction data so as to be a value between the value indicated by the first correction data and the value indicated by the second correction data; and a correction unit that, based on the updated correction data which is updated by the updating unit, generates the image data by correcting the present input image data and supplies the driving unit with the generated image data.

In this case, when the value which denotes the difference between the first correction data and the second correction data that correspond to each of the first pixel circuit and the second pixel circuit which are adjacent to each other in the extending direction of the scan line is equal to or greater than the predetermined threshold, the correction data is updated so as to decrease the difference between the value indicated by the first correction data and the value indicated by the second correction data.

For this reason, it is possible to reduce a probability of the change of a rapid display gradation caused by the vertical crosstalk correction being performed. More specifically, the change of the display gradation in the area between the two portions significantly different from each other in the display gradation, such as the area between the portion where the vertical crosstalk correction unnecessary to be performed is performed and a peripheral portion thereof, or the area between a portion where the vertical crosstalk correction necessary to be performed is not performed and a peripheral portion thereof, is possible to gradually occur compared to when the correction data is not updated.

As a result, even when the vertical crosstalk correction is performed, in the displayed image, a possibility of displaying a rapid change of the display gradation caused by the vertical crosstalk correction can be reduced, and even when the image such as the moving image is displayed, a high display quality can be realized.

In addition, in the above-described display control circuit, for example, the updating unit may update the plurality of correction data in such a manner that at least one value of the value indicated by the first correction data and the value indicated by the second correction data, becomes greater than the smaller value of the value indicated by the first correction data and the value indicated by the second correction data, and becomes less than the greater value of those.

In addition, according to another aspect of the invention, there is a display control circuit that is provided in an electro-optical device which includes a scan line; a plurality of data lines; a plurality of pixel circuits installed so as to correspond to an intersection between the scan line and the plurality of data lines; and a driving unit that, when image data is supplied, supplies an image signal generated based on the image data, through the data line, to a pixel circuit installed so as to correspond to the data line, the display control circuit supplying the driving unit with the image data, the display control circuit includes, a generation unit that, based on input image data supplied only for the unit time from the past to the present, generates correction data corresponding to an integration value which is obtained by integrating a voltage of the image signal supplied to each data line only for the unit time from the past to the present, so as to correspond to each of the plurality of pixel circuits; a specification unit that, when a correction difference value which denotes a difference between two pieces of correction data corresponding to two pixel circuits adjacent to each other in an extending direction of the scan line among the plurality of pixel circuits, is equal to or greater than a predetermined threshold, specifies the two pixel circuits as a boundary pixel circuit; an updating unit that includes at least one of the two pixel circuits which configure the boundary pixel circuit among the plurality of pixel circuits, specifies a predetermined number of pixel circuits which are consecutively installed in the extending direction of the scan line, modifies a value indicated by each of a predetermined number of pieces of correction data corresponding to the specified predetermined number of pixel circuits so as to be a value between two values indicated by two pieces of correction data corresponding to the two pixel circuits which configure the boundary pixel circuit, and thereby updating the plurality of pieces of correction data; and a correction unit that, based on the updated correction data which is updated by the updating unit, generates the image data by correcting the present input image data and supplies the driving unit with the generated image data.

In this case, when the correction difference value which denotes the difference between the two correction data corresponding to the two pixel circuits adjacent to each other in the extending direction of the scan line is equal to or greater than the predetermined threshold, the two pixel circuits are specified as the boundary pixel circuit, and thereafter, a predetermined number of pixel circuits including one or both of the two pixel circuits which configure the boundary pixel circuit, are specified. Then, the predetermined number of pieces of correction data corresponding to the predetermined number of pixel circuits is updated so as to be the value between the two correction data corresponding to the two pixel circuits which configure the boundary pixel circuit.

For this reason, it is possible to reduce a probability of the change of a rapid display gradation caused by the vertical crosstalk correction being performed. More specifically, the change of the display gradation in the area between the two portions significantly different from each other in the display gradation, is possible to gradually occur compared to when the correction data is not updated.

As a result, even when the vertical crosstalk correction is performed, in the displayed image, the possibility of displaying the rapid change of the display gradation caused by the vertical crosstalk correction can be reduced, and even when the image such as the moving image is displayed, the high display quality can be realized.

In addition, in the above-described display control circuit, for example, the updating unit may update the plurality of correction data, in such a manner that the value indicated by each of the predetermined number of pieces of updated correction data corresponding to the predetermined number of pixel circuits becomes greater than the smaller value of the two values indicated by the two pieces of correction data before being updated which correspond to the two pixel circuits configuring the boundary pixel circuit, and also becomes less than the greater value of the two values.

In addition, in the above-described display control circuit, the predetermined number of pixel circuits may include both of the two pixel circuits which configure the boundary pixel circuit, and the updating unit may specify the predetermined number of pixel circuits in such a manner that the number of pixel circuits installed in the other pixel circuit side of the two pixel circuits viewed from one pixel circuit of the two pixel circuits which configure the boundary pixel circuit among the predetermined number of pixel circuits, becomes equal to the number of pixel circuits installed in the one pixel circuit side viewed from the other pixel circuit among the predetermined number of pixel circuits.

In addition, in the above-described display control circuit, the updating unit may update the plurality of pieces of correction data, in such a manner that the value indicated by each of the predetermined number of pieces of updated correction data corresponding to the predetermined number of pixel circuits become values equal to each other.

In addition, in the above-described display control circuit, the updating unit may specify the predetermined number of pixel circuits, so as to include both of the two pixel circuits which configure the boundary pixel circuit, and the updating unit may update the plurality of pieces of correction data, in such a manner that the value indicated by the updated correction data corresponding to the pixel circuit installed in the other pixel circuit side of the two pixel circuits viewed from the one pixel circuit of the two pixel circuits which configure the boundary pixel circuit, among the predetermined number of pixel circuits, becomes the value between the value indicated by the updated correction data corresponding to the pixel circuit installed in the one pixel circuit side viewed from the other pixel circuit, among the predetermined number of pixel circuits, and the value indicated by the correction data before being updated which corresponds to the other pixel circuit.

In addition, the above-described display control circuit may further include a detection unit that detects an amount of movement of a predetermined object denoted in the center of an image displayed by the electro-optical device, and the amount of movement in the extending direction of the scan line during the unit time, and the updating unit determines the predetermined number of pixel circuits in response to the amount of movement.

Generally, the change of the rapid display gradation caused by the vertical crosstalk correction being performed, occurs by a movement of the object denoted in the center of the moving image, when the displayed image is the moving image.

In this case, since an amount of movement of the object is detected, the magnitude of the area between the two portions different from each other in the display gradation can be accurately grasped. Thus, even when the vertical crosstalk correction is performed, in the displayed image, the possibility of displaying the rapid change of the display gradation caused by the vertical crosstalk correction can be reduced, and even when the image such as the moving image is displayed, the high display quality can be realized.

In addition, only for the unit time from the past to the present, the object is denoted in the center of the image displayed in the electro-optical device and one of the two data lines corresponding to the boundary pixel circuit specified by the specification unit as an end portion is set, and the detection unit may detect the amount of movement in which the object moves in the extending direction of the scan line during the unit time.

In addition, in the above-described display control circuit, the amount of movement may be the number of pixels of the image which move during the unit time, and the updating unit updates the predetermined number of pixel circuits, in such a manner that one or both of the number of pixel circuits installed in the other pixel circuit side of the two pixel circuits viewed from the one pixel circuit of the two pixel circuits which configure the boundary pixel circuit, among the predetermined number of pixel circuits, and the number of pixel circuits installed in the one pixel circuit side viewed from the other pixel circuit, among the predetermined number of pixel circuits, becomes equal to the amount of movement.

In addition, according to still another aspect of the invention, there is provided an electro-optical device including the above-described display control circuit; a scan line; a plurality of data lines; a plurality of pixel circuits that are installed so as to correspond to an intersection between the scan line and the plurality of data lines; and a driving unit that, when image data is supplied, supplies an image signal generated based on the image data, through the data line, to the pixel circuits installed so as to correspond to the data line.

In addition, in the above-described electro-optical device, the driving unit may generate the image signal so as to invert a polarity of the signal with a reference level serving as a center during a predetermined period, and the generation unit generates correction data corresponding to the pixel circuits installed so as to correspond to one data line, based on an integration value obtained by performing one of addition and subtraction, in response to the polarity, of the input image data corresponding to the one data line, among the input image data supplied only for the unit time from the past to the present.

In addition, according to still another aspect of the invention, there is provided the electronic apparatus including the electro-optical device which includes any one of the above-described display control circuits, or including any one of the above-described electro-optical devices. As such an electronic apparatus, there are a car navigation device, a personal computer, a television, a projection type display device, a cellular phone and the like.

### BRIEF DESCRIPTION OF THE DRAWINGS

The invention will be described with reference to the accompanying drawings, wherein like numbers reference like elements.

FIG. 1 is a block diagram of an electro-optical device according to a first embodiment of the invention.

FIG. 2 is a circuit diagram of a pixel circuit.

FIG. 3 is a block diagram of a signal generation circuit.

FIG. 4 is a timing chart for explaining an operation of the electro-optical device.

FIG. 5 is an explanatory diagram for explaining first integration data which is stored in a first storage unit.

FIG. 6 is an explanatory diagram for explaining second integration data which is stored in a second storage unit.

FIGS. 7A to 7E are explanatory diagrams for explaining a process of updating integration data.

FIGS. 8A and 8B are explanatory diagrams for explaining a vertical crosstalk correction.

FIGS. 9A to 9D are explanatory diagrams for explaining a relationship between correction data and a display gradation.

FIG. 10 is an explanatory diagram for explaining the vertical crosstalk correction.

FIGS. 11A to 11D are explanatory diagrams for explaining the relationship between the correction data and the display gradation.

FIGS. 12A to 12D are explanatory diagrams for explaining a relationship between updated correction data and the display gradation.

FIG. 13 is a block diagram of a signal generation circuit according to a second embodiment of the invention.

FIGS. 14A to 14D are explanatory diagrams for explaining the relationship between the updated correction data and the display gradation.

FIG. 15 is a perspective view of an electronic apparatus (projection type display apparatus).

FIG. 16 is a perspective view of an electronic apparatus (personal computer).

FIG. 17 is a perspective view of an electronic apparatus (cellular phone).

FIG. 18 is an explanatory diagram for explaining generation method of updated correction data according to modification example 3 of the invention.

### DESCRIPTION OF EXEMPLARY EMBODIMENTS

Hereinafter, a form for performing the invention will be described with reference to the drawings. However, in the drawings, a size and a scale of each portion are appropriately different from actual ones. In addition, since the actual embodiments described below are preferred specific examples of the invention, technically preferable various limitations are attached thereto, however, the scope of the invention is not limited to these embodiments so far as there is no description of particularly limiting the invention in the following explanation.

### A. First Embodiment

FIG. 1 is a block diagram of an electro-optical device 1 according to a first embodiment of the present invention.

The electro-optical device 1 includes an electro-optical panel 10 and a signal generation circuit 20. The electro-optical panel 10 includes a display unit 30 in which a plurality of pixel circuits PX are arranged, and a driving circuit 40 which drives each pixel circuit PX.

In the display unit 30, M scan lines 32 extending in the x direction and N data lines 34 which extends in the y direction and intersects the x direction, are formed (M and N are natural numbers). The plurality of pixel circuits PX are arranged in a matrix with M vertical rows×N horizontal columns in the display unit 30 corresponding to each intersection of the scan line 32 and the data line 34. In addition, in the present embodiment, the pixel circuits PX are all arranged at the intersections of M×N numbers formed by the M scan lines 32 and the N data lines 34, but may be arranged at portions of the intersections of M×N numbers.

The driving circuit 40 is a circuit that supplies each pixel circuit PX with an image signal VD[n] (n=1 to N) which controls the display gradation of the pixel corresponding to each pixel circuit PX, and includes a scan line driving circuit 42 and a data line driving circuit 44.

The scan line driving circuit 42 sequentially selects each scan line 32 by supplying each scan line 32 with scan signals Y[1] to Y[M] corresponding to each scan line 32. Specifically, a scan signal Y[m] (m=1 to M) is set to a predetermined selection potential (that is, the scan line 32 of an mth row is selected), whereby the scan line 32 of the mth row is selected.

The data line driving circuit 44 supplies each of the N data lines 34 with image signals VD[1] to VD[N] in synchronization with a scan line 32 selected by the scan line driving circuit 42. An image signal VD[n] (n=1 to N) is variably set in response to the display gradation in which input image data Din described later is designated with respect to a pixel corresponding to each pixel circuit PX.

In order to prevent so-called burn-in, the present embodiment employs a polarity inversion driving in which a polarity of a voltage applied to a liquid crystal element 60 described later is inverted during a predetermined period. In this example, a signal level of the image signal VD[n] is inverted for each unit period with a predetermined reference potential Vref serving as a center.

Here, the unit period is a period of one unit of an operation in which the pixel circuit PX operates. In the present embodiment, time length with the unit period is referred to as a unit time. In the present embodiment, the unit period is set as a vertical scan period. However, the unit period can be arbitrarily set, for example, may be n times (n is a natural number) the vertical scan period.

FIG. 2 is a circuit diagram of each pixel circuit PX. As illustrated in FIG. 2, each pixel circuit PX includes the liquid crystal element 60 and a selection switch SW. The liquid crystal element 60 is an electro-optical element configured to have a pixel electrode 62 and a common electrode 64 which oppose each other, and a liquid crystal 66 between the two electrodes 62 and 64. In response to a voltage applied between the pixel electrode 62 and the common electrode 64, a transmittance rate (display gradation) of the liquid crystal 66 changes. In addition, a configuration in which an auxiliary capacitor is connected in parallel to the liquid crystal element 60 can also be employed. For example, the selection switch SW is configured from an N-channel transistor whose gate is connected to the scan line 32, connects the liquid crystal element 60 to the data line 34, and controls an electrical connection (conduction or insulation) of the liquid crystal element 60 and the data line 34. The scan signal Y[m] is set to a selection potential, whereby the selection switches SW in each pixel circuit PX in the mth row are simultaneously transitioned to an ON state.

When the scan line 32 corresponding to the pixel circuits PX is selected, and the selection switch SW of the pixel circuit PX is controlled to be in the ON state, the image signal VD[n] from the data line 34 is supplied to the pixel circuit PX, and a voltage responding to the image signal VD[n] is applied to the liquid crystal element 60 of the pixel circuit PX. As a result, the transmittance rate of the liquid crystal 66 in the pixel circuit PX is set in response to the image signal VD[n], and the pixel corresponding to the pixel circuit PX displays the gradation in response to the image signal VD[n].

After the voltage in response to the image signal VD[n] is applied to the liquid crystal element 60 of the pixel circuit PX, when the selection switch SW is in the OFF state, the applied voltage responding to the image signal VD[n] is retained, ideally. Thus, ideally, each pixel displays the gradation responding to the image signal VD[n], during the period between a state where the selection switch SW is firstly switched on and a state where the selection switch SW is secondly switched on.

However, actually, as illustrated in FIG. 2, a capacitor Ca is parasitic between the data line 34 and the pixel electrode 62 (or between the data line 34 and a wire which electrically connects the pixel electrode 62 to the selection switch SW). For this reason, while the selection switch SW is in an OFF state, potential variation of the data line 34 is transferred to the pixel electrode 62 through the capacitor Ca, whereby the voltage applied to the liquid crystal element 60 can be varied. At this time, the pixel cannot correctly display the gradation responding to the image signal VD[n].

The explanation returns to FIG. 1. As illustrated in FIG. 1, input image data Din from a higher-level device which is not illustrated, is supplied to the signal generation circuit 20 in synchronization with a synchronization signal. Here, the input image data Din is data which defines gradation to be displayed in the pixel corresponding to each pixel circuit PX. For example, the input image data Din may be digital data which defines the gradation to be displayed by each pixel as 8 bits. In addition, hereinafter, there is a case where, input image data Din, among the input image data Din, which designates the gradation with respect to the M pixel circuits PX located in an nth column, is referred to as input image data Din[n] (n=1 to N), and the input image data Din which designates the gradation with respect to one pixel circuit PX[m][n] located in the mth row and the nth column, is referred to as input image data Din[m][n] (m=1 to M). In addition, the synchronization signal is a signal which includes, for example, a vertical synchronization signal, a horizontal synchronization signal, and a dot clock signal.

Based on the synchronization signal supplied from the higher-level device, the signal generation circuit 20 generates a control signal Ctr which is a signal for controlling an operation of the electro-optical panel 10, and supplies the driving circuit 40 with the generated control signal Ctr. Here, the control signal Ctr is a signal which includes, for example, a pulse signal, a clock signal, an enable signal or the like. In addition, the control signal Ctr may include a polarity signal P described later.

In addition, based on the input image data Din, the signal generation circuit 20 generates image data Dx, and supplies the data line driving circuit 44 with the generated image data Dx. In the present embodiment, the image data Dx is a digital signal, but may be an analog signal.

In addition, hereinafter, there is a case where image data Dx, among the image data Dx, which is generated based on the input image data Din[n], is referred to as image data Dx[n] (n=1 to N). In addition, there is a case where image data Dx, among the image data Dx[n], which is generated based on the input image data Din[m][n], is referred to as image data Dx[m][n] (m=1 to M).

FIG. 3 is a functional block diagram which illustrates a configuration of the signal generation circuit 20. As illustrated in FIG. 3, the signal generation circuit 20 includes a control unit 21 which generates various signals such as the control signal Ctr based on the synchronization signal, a generation unit 22 which generates correction data Dh based on the input image data Din, a specification unit 25 which generates a determination value Q based on the correction data Dh, an updating unit 26 which outputs updated correction data Dk by updating the correction data Dh based on the correction data Dh and the determination value Q, and a correction unit 27 which generates the image data Dx by performing a vertical crosstalk correction with respect to the input image data Din based on the updated correction data Dk.

Hereinafter, each configuration element of the signal generation circuit 20 will be individually described.

Based on the synchronization signal supplied from the higher-level device, the control unit 21 generates the control signal Ctr and supplies the driving circuit 40 with the generated control signal. In addition, the control unit 21 supplies the generated control signal Ctr to each configuration element of the signal generation circuit 20 such as the updating unit 26 or the correction unit 27 (not illustrated). In addition, based on the control signal Ctr or the synchronization signal, the control unit 21 generates a reset signal RES and the polarity signal P.

Here, the reset signal RES is a signal which includes a first reset signal RES1 for initializing storage content of a first storage unit 232 described later, and a second reset signal RES2 for initializing storage content of a second storage unit 242 described later. In addition, the polarity signal P is a signal which represents the polarity of the image signal VD[n].

Based on the input image data Din, the generation unit 22 generates correction data Dh which is used when the vertical crosstalk correction with respect to the input image data Din is performed. More specifically, the generation unit 22 generates the correction data Dh which includes N pieces of correction data Dh[1] to Dh[N] corresponding one-to-one to the N data lines 34. Among these, the correction data Dh[n] (n=1 to N) is data which is used when the vertical crosstalk correction with respect to the input image data Din[n] corresponding to the pixel circuit PX of the nth column among the input image data Din is performed.

In addition, there is a case where the data, among the correction data Dh[n], which is used when the vertical crosstalk correction with respect to the input image data Din[m][n] corresponding to the pixel circuit PX[m][n] located in the mth row and the nth column is performed, is referred to as correction data Dh[m][n] (m=1 to M). That is, the correction data Dh[n] includes correction data Dh[1][n] to Dh[M][n].

The generation unit 22 sequentially outputs the correction data Dh from the correction data Dh corresponding to the pixel circuits PX which are located in a first row. Specifically, the generation unit 22 generates to output the correction data Dh in the order of correction data Dh[1][n] (n=1 to N) corresponding to N pixel circuits PX located in the first row→correction data Dh[2][n] (n=1 to N) corresponding to N pixel circuits PX located in a second row→ . . . →correction data Dh[M][n] (n=1 to N) corresponding to N pixel circuits PX located in an Mth row.

In addition, with regard to the N correction data Dh corresponding to the N pixel circuit PX located in each row, the generation unit 22 sequentially outputs the correction data Dh from the correction data Dh corresponding to the pixel circuit PX of the first column. Specifically, with regard to the correction data Dh[m][1] to Dh[m][N] of the mth row, the generation unit 22 generates and outputs the correction data Dh in the order of Dh[m][1]→Dh[m][2]→ . . . →Dh[m][N].

The generation unit 22 includes a first generation unit 23 and a second generation unit 24.

Among these, the first generation unit 23 includes a first computation unit 231 and a first storage unit 232. The first storage unit 232 stores a first integration data DS1 which is data for generating the correction data Dh. The first integration data DS1 includes N pieces of the first integration data DS1[1] to DS1[N] corresponding one-to-one to the N data lines 34.

The first computation unit 231 updates the first integration data DS1 stored in the first storage unit 232, based on the input image data Din and the polarity signal P, and initializes the first integration data DS1, based on the first reset signal RES1. In addition, the first computation unit 231 generates the correction data Dh based on the first integration data DS1. More specifically, the first computation unit 231 generates the correction data Dh by multiplying the first integration data DS1 by a negative coefficient.

Hereinafter, there is a case where the first integration data DS1, among the first integration data DS1[n] (n=1 to N), which is for generating the correction data Dh[m][n], is referred to as first integration data DS1[m][n] (m=1 to M). That is, the first computation unit 231 generates the correction data Dh[m][n] for performing the vertical crosstalk correction with respect to the input image data Din[m][n], by multiplying the first integration data DS1[m][n] by the negative coefficient.

In addition, the first computation unit 231 generates the correction data Dh only when the polarity indicated by the polarity signal P is negative.

The second generation unit 24 includes a second computation unit 241 and a second storage unit 242.

The second storage unit 242 stores a second integration data DS2 which is data for generating the correction data Dh. The second integration data DS2 includes N pieces of the second integration data DS2[1] to DS2[N] corresponding one-to-one to the N data lines 34.

The second computation unit 241 updates the second integration data DS2 stored in the second storage unit 242, based on the input image data Din and the polarity signal P, and initializes the second integration data DS2, based on the second reset signal RES2. In addition, the second computation unit 241 generates the correction data Dh based on the second integration data DS2. More specifically, the second computation unit 241 generates the correction data Dh by multiplying the second integration data DS2 by the negative coefficient.

Hereinafter, there is a case where the second integration data DS2, among the second integration data DS2[n] (n=1 to N), which is for generating the correction data Dh[m][n], is referred to as second integration data DS2[m][n] (m=1 to M). That is, the second computation unit 241 generates the correction data Dh[m][n] for performing the vertical crosstalk correction with respect to the input image data Din[m][n], by multiplying the second integration data DS2[m][n] by the negative coefficient.

The second computation unit 241 generates the correction data Dh only when the polarity indicated by the polarity signal P is positive. That is, in the generation unit 22, when the polarity indicated by the polarity signal P is negative, the first computation unit 231 generates the correction data Dh, and conversely, when the polarity indicated by the polarity signal P is positive, the second computation unit 241 generates the correction data Dh.

In addition, hereinafter, there is a case where the first integration data DS1 and the second integration data DS2 are collectively referred to as integration data DS.

Processing of updating and initializing the integration data DS in the first computation unit 231 and the second computation unit 241 which are included in the generation unit 22, and a process of generating the correction data Dh will be described in detail later.

The specification unit 25 is installed so as to correspond to the same scan lines 32, and determines whether or not a correction difference value ΔDh which is a difference between two values indicated by two pieces of correction data Dh corresponding to two pixel circuits PX adjacent to each other in the extending direction of the scan line 32, is equal to or greater than a predetermined threshold δ. Specifically, the specification unit 25 first calculates the correction difference value ΔDh which is a difference between a value indicated by the correction data Dh[m][n−1] corresponding to the pixel circuit PX[m][n−1] located in the mth row and the (n−1)th column, and a value indicated by the correction data Dh[m][n] corresponding to the pixel circuit PX[m][n] located in the mth row and the nth column. Next, the specification unit 25 determines whether or not the calculated correction difference value ΔDh is equal to or greater than the predetermined threshold δ.

Then, when the determination result is yes, the specification unit 25 specifies the two pixel circuits PX as a boundary pixel circuit. Specifically, when the correction difference value ΔDh which is the difference between the value indicated by the correction data Dh[m][n−1] and the value indicated by the correction data Dh[m][n] is equal to or greater than the predetermined threshold δ, the specification unit 25 specifies the two pixel circuits PX (pixel circuits PX[m][n−1] and PX[m][n]) corresponding to such two pieces of correction data Dh, as the boundary pixel circuit. In addition, hereinafter, there is a case where a line segment which divides the two pixel circuits PX configuring the boundary pixel circuit is referred to as “boundary”.

In addition, hereinafter, there is a case where, when the pixel circuits PX[m][n−1] and PX[m][n] are specified as the boundary pixel circuit, the pixel circuit PX[m][n−1] is referred to as “a first pixel circuit”, the pixel circuit PX[m][n] “a second pixel circuit”, the data line 34 of the (n−1)th column “a first data line”, the data line 34 of the nth column “a second data line”, the correction data Dh[m][n−1] “a first correction data”, and the correction data Dh[m][n] “a second correction data”.

When the determination result is positive, the specification unit 25 sets the determination value Q as a value, for example, “1”, which indicates the positive determination result, and outputs the value. In addition, when the pixel circuits PX[m][n] and PX[m][n−1] are specified as the boundary pixel circuit, the specification unit 25 supplies the updating unit 26 with the determination value Q, within a period during which the generation unit 22 supplies the updating unit 26 with the correction data Dh[m][n].

On the other hand, when the determination result is negative, the specification unit 25 sets the determination value Q as a value, for example, “0”, which indicates the negative determination result, and outputs the value.

When the specification unit 25 specifies the boundary pixel circuit, the updating unit 26 specifies the boundary pixel circuit and a predetermined number Z of pixel circuits PX which are consecutive in the extending direction of the scan line 32, as a target pixel circuit. Here, the predetermined number Z is a 2 or more integer determined in advance.

For example, it is assumed that the generation unit 22 outputs the correction data Dh[m][n], and further, the specification unit 25 specifies the pixel circuits PX[m][n] and PX[m][n−1] as the boundary pixel circuit and outputs the determination value Q which is set as the value “1” indicates the positive determination result.

At this time, the updating unit 26 specifies “W1+W2” pieces of pixel circuits PX[m][n−W1] to PX[m][n+(W2−1)] that are configured to have W1 pieces of pixel circuits PX which are located on the left side (that is, left side of the boundary) of the pixel circuit PX[m][n] in FIG. 1 and include the pixel circuit PX[m][n−1], and W2 pieces of pixel circuits PX which are located on the right side (that is, right side of the boundary) of the pixel circuit PX[m][n−1] in FIG. 1 and include the pixel circuit PX[m][n], and are consecutive in the extending direction of the scan line 32, as the target pixel circuit.

Here, the values W1 and W2 are W1>0 and W2>0, respectively, satisfy “W1+W2=Z”, and are positive integers determined in advance. In addition, in the present embodiment, the values W1 and W2 are the same values as each other.

In addition, hereinafter, there is a case where each pixel circuit PX, among the target pixel circuits, which is located on the left side of the boundary, is referred to as “left target pixel circuit PXL”, and each pixel circuit PX, among the target pixel circuits, which is located on the right side of the boundary, is referred to as “right target pixel circuit PXR”. That is, the target pixel circuits are configured from W1 pieces of the left target pixel circuits PXL and W2 pieces of the right target pixel circuits PXR.

In the present embodiment, both the value W1 and the value W2 are “4”. That is, in the present embodiment, the predetermined number Z is “8”, and when the pixel circuits PX[m][n] and PX[m][n−1] are specified as the boundary pixel circuit, the target pixel circuits are pixel circuits PX[m][n−4] to PX[m][n+3].

However, when n is “n−4<1”, the value W1 is set to a value which is “n−W1=1”, exceptionally. In addition, when n is “n+3>N”, the value W2 is set to a value which is “n+W2−1=N”, exceptionally.

When the target pixel circuit is specified, the updating unit 26 modifies in such a manner that each of the predetermined number Z of values indicated by the predetermined number Z of pieces of correction data Dh corresponding to the predetermined number Z of pixel circuits PX which configure the target pixel circuits may be a value between two values indicated by the two pieces of correction data Dh corresponding to the two pixel circuits PX configuring the boundary pixel circuit.

For example, when the pixel circuits PX[m][n−1] and PX[m][n] are specified as the boundary pixel circuit and as the result, the pixel circuits PX[m][n−W1] to PX[m][n+(W2−1)] are specified as the target pixel circuits, the updating unit 26 modifies in such a manner that each of the predetermined number Z of values indicated by the predetermined number Z of pieces of correction data Dh[m][n−W1] to Dh[m][n+(W2−1)] corresponding to the target pixel circuits may be a value between two values indicated by the two pieces of correction data Dh[m][n−1] and Dh[m][n] corresponding to the boundary pixel circuit. Thus, the updating unit 26 generates the predetermined number Z of pieces of updated correction data Dk[m][n−W1] to Dk[m][n+(W2−1)] corresponding one-to-one to the predetermined number Z of pieces of correction data Dh[m][n−W1] to Dh[m][n+(W2−1)].

More specifically, when the value indicated by the correction data Dh[m][n−1] is smaller than the value indicated by the correction data Dh[m][n], the updating unit 26 generates the updated correction data Dk corresponding to each of the left target pixel circuits PXL, by adding a modified value C1 to the value indicated by the correction data Dh corresponding to each of the left target pixel circuits PXL. Also, the updating unit 26 generates the updated correction data Dk corresponding to each of the right target pixel circuits PXR, by subtracting a modified value C2 from the value indicated by the correction data Dh corresponding to each of the right target pixel circuits PXR.

That is, at this time, for example, the values indicated by the updated correction data Dk[m][n−W1] and Dk[m][n+(W2−1)] are each denoted by the following equations (1) and (2). In addition, in the following equations, for convenience of description, values indicated by various data such as the correction data Dh or the updated correction data Dk are represented by the symbols given for the data such as “Dh” or “Dk”.

Dk[m][n−W1]=Dh[m][n−W1]+C1 Equation (1)

Dk[m][n+(W2−1)]=Dh[m][n+(W2−1)]−C2 Equation (2)

Here, the modified values C1 and C2 according to the present embodiment are predetermined values determined in advance. In addition, the modified values C1 and C2 according to the present embodiment are the same values as each other.

In addition, the modified values C1 and C2 may be values determined in response to the correction difference value ΔDh. For example, the modified values C1 and C2 may be values multiplied by a predetermined coefficient, for example, “0.3” which is smaller than “1” with respect to the correction difference value ΔDh.

On the other hand, when the value indicated by the correction data Dh[m][n−1] is a value greater than the value indicated by the correction data Dh[m][n], the updating unit 26 generates the updated correction data Dk corresponding to each of the left target pixel circuits PXL, by subtracting the modified value C1 from the value indicated by the correction data Dh corresponding to each of the left target pixel circuits PXL. Also, the updating unit 26 generates the updated correction data Dk corresponding to each of the right target pixel circuits PXR, by adding the modified value C2 to the value indicated by the correction data Dh corresponding to each of the right target pixel circuits PXR.

That is, at this time, for example, the values indicated by the updated correction data Dk[m][n−W1] and Dk[m][n+(W2−1)] are each denoted by the following equations (3) and (4).

Dk[m][n−W1]=Dh[m][n−W1]−C1 Equation (3)

Dk[m][n+(W2−1)]=Dh[m][n+(W2−1)]+C2 Equation (4)

The updating unit 26 specifies the target pixel circuits, and temporarily stores time necessary to generate the updated correction data Dk by modifying the correction data Dh, and the correction data Dh[m][n] supplied from the generation unit 22.

That is, after retaining the correction data Dh[m][n] supplied from the generation unit 22 until the correction data Dh[m][n+Z−1] is supplied from the generation unit 22, the updating unit 26 generates the updated correction data Dk[m][n] corresponding to the correction data Dh[m][n], and outputs the generated updated correction data Dk[m][n].

In addition, when the pixel circuit PX[m][n] corresponding to the correction data Dh[m][n] is not the target pixel circuit, after retaining the correction data Dh[m][n] until the correction data Dh[m][n+Z−1] is supplied from the generation unit 22, the updating unit 26 outputs the correction data Dh[m][n] as the updated correction data Dk[m][n]. That is, when the pixel circuit PX[m][n] corresponding to the correction data Dh[m][n] is not the target pixel circuit, the updated correction data Dk[m][n] is equal to the correction data Dh[m][n].

Based on the updated correction data Dk[m][n] supplied by the updating unit 26, the correction unit 27 performs the vertical crosstalk correction with respect to the input image data Din[m][n], and then generates the image data Dx[m][n]. More specifically, the correction unit 27 generates the image data Dx[m][n], by adding the updated correction data Dk[m][n] to the input image data Din[m][n].

In addition, the correction unit 27 may generate the image data Dx[m][n] by performing a gamma correction with respect to an addition value which is obtained by adding the input image data Din[m][n] to the updated correction data Dk[m][n]. Then, the correction unit 27 supplies the data line driving circuit 44 with the image data Dx[m][n].

FIG. 4 is a timing chart illustrating an operation of the electro-optical device 1.

As illustrated in FIG. 4, an operation period of the electro-optical device 1 is formed of a plurality of display periods F. Each display period F is divided into a predetermined length of an unit period P1 and a predetermined length of an unit period P2 following the unit period P1.

In addition, as described above, the data line driving circuit 44 generates the image signal VD[n] obtained by inverting the signal level for each unit period with the predetermined reference potential Vref serving as a center, based on the image data Dx[n]. More specifically, the data line driving circuit 44 generates a positive image signal VD[n] which is a high voltage with respect to a predetermined reference potential Vref, during the unit period P1, and generates a negative image signal VD[n] which is a low voltage with respect to the predetermined reference potential Vref, during the unit period P2.

The polarity signal generated by the control unit 21 denotes a polarity of such an image signal VD[n]. That is, when the polarity signal P is at a high level, the image signal VD[n] becomes positive, and when the polarity signal P is at a low level, the image signal VD[n] becomes negative.

Among the reset signals RES, the first reset signal RES1 is a signal which becomes a high level at the time when the display period F starts, that is, at the time when the unit period P2 of one display period F ends, and then the unit period P1 of a different display period F following the display period F starts, and the second reset signal RES2 is a signal which becomes a high level at the time when the unit period P1 of each display period F ends, and then the unit period P2 of the display period F starts.

In the generation unit 22, the first computation unit 231 initializes the content of the first integration data DS1 which is stored in the first storage unit 232, when the value indicated by the first reset signal RES1 supplied from the control unit 21 becomes a high level, and the second computation unit 241 initializes the content of the second integration data DS2 which is stored in the second storage unit 242, when the value indicated by the second reset signal RES2 supplied from the control unit 21 becomes a high level.

In addition, as illustrated in FIG. 4, the first computation unit 231 operates in a preparation mode to prepare for generating the correction data Dh during the unit period P1, and operates in a correction mode to generate the correction data Dh during the unit period P2. On the other hand, the second computation unit 241 operates in the preparation mode during the unit period P2, and operates in the correction mode during the unit period P1.

Hereinafter, with reference to FIGS. 5 to 7E, updating (generation) and initiation of the integration data DS (first integration data DS1 and second integration data DS2) performed by the generation unit 22 will be described.

FIG. 5 is an explanatory diagram illustrating an example of content of the first integration data DS1[n] (n=1 to N) stored in the first storage unit 232, and FIG. 6 is an explanatory diagram illustrating an example of content of the second integration data DS2[n] (n=1 to N) stored in the second storage unit 242. In addition, FIGS. 7A to 7E are explanatory diagrams for explaining updating of the first integration data DS1[n] performed by the first computation unit 231. In such figures, it is assumed that M=6, that is, the six (six rows) pixel circuits PX corresponding to each data line 34 are installed.

As illustrated in FIG. 5, when the first reset signal RES1 is supplied at the time when the unit period P1 starts, the first computation unit 231 initializes storage content of the first storage unit 232.

In addition, in the present embodiment, the initialization is a process of setting a value of the first integration data DS1[n] or the second integration data DS2[n] which is stored in the first storage unit 232 or the second storage unit 242, as a predetermined value such as “0”. However, for example, the initialization may be a process of erasing (or setting a Null value) the storage content of the first storage unit 232 or the second storage unit 242.

when the unit period P1 starts, the first computation unit 231 updates the first integration data DS1[n], by adding or subtracting the input image data Din[n] to or from the first integration data DS1[n] stored in the first storage unit 232. Which computation of the addition and the subtraction the first computation unit 231 performs is determined based on the polarity indicated by the polarity signal P.

Hereinafter, The process of updating (generating) the first integration data DS1[n], which is performed by the first computation unit 231, will be described in detail.

As illustrated in FIG. 5, during the unit period P1 in which the polarity signal P indicates a positive polarity, the first computation unit 231 updates the first integration data DS1[n] by adding the input image data Din[n] to the first integration data DS1[n] stored in the first storage unit 232.

Specifically, first, at the time when the unit period P1 starts, the first computation unit 231 initializes the first integration data DS1[n], by setting the first integration data DS1[n] stored in the first storage unit 232 as the initial value “0”.

Next, when the input image data Din[1][n], which is the input image data Din[n] supplied at first during the unit period P1, is supplied, the first computation unit 231 adds together the value “d11” indicated by the input image data Din[1][n] and the value “0” of the first integration data DS1[n] stored in the first storage unit 232, and updates the first integration data DS1[n] by storing the added value “d11” in the first storage unit 232 as the first integration data DS1[n].

Next, when the input image data Din[2][n] is supplied, the first computation unit 231 adds together a value “d12” indicated by the input image data Din[2][n] and the value “d11” of the first integration data DS1[n] stored in the first storage unit 232, and updates the first integration data DS1[n] by storing the added value “d11+d12” in the first storage unit 232 as the first data DS1[n].

Hereafter, the first computation unit 231 repeats the same process until the unit period P1 ends. As a result, at the time when the unit period P1 ends, a total value “d11+d12+d13+d14+d15+d16” of the values “d11 to d16” indicated by the input image data Din[1][n] to Din[6][n] is stored in the first storage unit 232 as the first integration data DS1[n].

In this way, at the time when the unit period P1 ends, an integration value S0 (=d11+d12+d13+d14+d15+d16) obtained by integrating the input image data Din[n] only for the unit time from the past to the present, is stored in the first storage unit 232 as the first integration data DS1[n], as illustrated in FIG. 7A. In other words, the first integration data DS1[n] stored in the first storage unit 232 at the time when the unit period P1 ends, corresponds to the integration value obtained by integrating the image signal VD[n] only for the unit time from the past to the present.

In addition, as described above, only during the unit period P2 in which the polarity indicated by the polarity signal P is negative, the first computation unit 231 generates the correction data Dh based on the first integration data DS1. That is, the first computation unit 231 does not generate the correction data Dh based on the first integration data DS1, during the unit period P1.

As illustrated FIG. 5, during the unit period P2 in which the polarity signal P indicates a negative polarity, the first computation unit 231 updates the first integration data DS1[n] by subtracting a value obtained by doubling a value indicated by the input image data Din[n], from the first integration data DS1[n] stored in the first storage unit 232.

Specifically, when the unit period P2 starts and the input image data Din[1][n] which is the input image data Din[n] supplied at first during the unit period P2 is supplied, the first computation unit 231 updates the first integration data DS1[n] by subtracting the value obtained by doubling the value “d21” indicated by the input image data Din[1][n] from the value “d11+d12+d13+d14+d15+d16” of the first integration data DS1[n] stored in the first storage unit 232, and then by storing the subtracted value “d11+d12+d13+d14+d15+d16−2×d21” in the first storage unit 232 as the first integration data DS1[1][n].

Next, when the input image data Din[2][n] is supplied, the first computation unit 231 updates the first integration data DS1[n] by subtracting a value obtained by doubling a value “d22” indicated by the input image data Din[2][n] from the value “d11+d12+d13+d14+d15+d16−2×d21” of the first integration data DS1[n] stored in the first storage unit 232, and then by storing the subtracted value “d11+d12+d13+d14+d15+d16−2×d21−2×d22” in the first storage unit 232 as the first integration data DS1[2][n].

Hereafter, the first computation unit 231 repeats the same process until the unit period P2 ends. Then, at the time when the unit period P2 ends, or at the time after the unit period P2 has ended, the first computation unit 231 sets the first integration data DS1[n] stored in the first storage unit 232 as the initial value “0”.

When an image displayed on the display unit 30 is a still image, a display gradation which is designated by the input image data Din with respect to a certain pixel during the unit period P1, and a display gradation which is designated during the unit period P2 are the same.

In addition, even when an image displayed on the display unit 30 is a moving image and there occurs a change, which is associated with movement of the image, in the display gradation of each pixel, it is normal that the change in the display gradation of each pixel during the unit period (or display period) be small enough to be regarded as having no change in the display gradation. Thus, even when the image displayed on the display unit 30 is a moving image, the display gradation which is designated by the input image data Din with respect to a certain pixel during the unit period P1, and the display gradation which is designated during the unit period P2 can be regarded as the same as each other.

In this way, the value “d11” indicated by the input image data Din[1][n] during the unit period P1 can be regarded as the same as the value “d21” indicated by the input image data Din[1][n] during the unit period P2.

Thus, as illustrated in FIGS. 7A and 7B, at the time when the unit period P2 starts, a value obtained by subtracting the value “d21” indicated by the input image data Din[1][n] from the value “d11+d12+d13+d14+d15+d16 (=the integration value S0)” indicated by the first integration data DS1[n] stored in the first storage unit 232, can be regarded as the same as the value “d12+d13+d14+d15+d16”. Then, the value obtained by subtracting the value “d21” from the value “d12+d13+d14+d15+d16” can be regarded as the same as the integration value S1=“d12+d13+d14+d15+d16−d21” illustrated in FIG. 7B. That is, an integration value S1 and the first integration data DS1[1][n] can be regarded as same value as each other, as illustrated in the following equation (5).

DS1[1][n]≅S1(=d12+d13+d14+d15+d16−d21) Equation (5)

In the same manner, as illustrated in FIGS. 7A to 7E or the following equations (6) to (10), even the first integration data DS1[2][n] to DS1[6][n] which are generated by the first computation unit 231 during the unit period P2 can be regarded as the same as the integration value S2 to S6.

DS1[2][n]≅S2(=d13+d14+d15+d16−d21−d22) Equation (6)

DS1[3][n]≅S3(=d14+d15+d16−d21−d22−d23) Equation (7)

DS1[4][n]≅S4(=d15+d16−d21−d22−d23−d24) Equation (8)

DS1[5][n]≅S5(=d16−d21−d22−d23−d24−d25) Equation (9)

DS1[6][n]≅S6(=−d21−d22−d23−d24−d25−d26) Equation (10)

In this way, the value indicated by the first integration data DS1[n] generated by the first computation unit 231 during the unit period P2, can be regarded as the same as the integration value obtained by integrating the input image data Din[1] only for the unit time from the past to the present. In other words, the first integration data DS1[m][n] generated by the first computation unit 231 during the unit period P2, corresponds to the integration value obtained by integrating the image signal VD[n] only for the unit time from the past to the present.

During the unit period P2, the second computation unit 241 performs a process of adding the input image data Din[n] performed by the first computation unit 231 during the unit period P1 to the integration data DS. In addition, during unit period P1, the second computation unit 241 performs a process of subtracting a value obtained by doubling the value indicated by the input image data Din[n] performed by the first computation unit 231 during the unit period P2, from the integration data DS1.

Specifically, as illustrated in FIG. 6, when the second reset signal RES2 is supplied at the time when the unit period P2 starts, the second computation unit 241 initializes the storage content of the first storage unit 232.

When the unit period P2 starts, the second computation unit 241 updates the second integration data DS2[n] by adding the input image data Din[n] to the second integration data DS2[n] stored in the second storage unit 242. As a result, at the time when the unit period P2 ends, the total value “d21+d22+d23+d24+d25+d26” of the values “d21” to “d26” indicated by the input image data Din[1][n] to Din[6][n] is stored as the second integration data DS2[n], in the second storage unit 242. That is, at the time when the unit period P2 ends, the integration value S0′ (=d21+d22+d23+d24+d25+d26) obtained by integrating the input image data Din[n] only for the unit time from the past to the present is stored as the second integration data DS2[n], in the second storage unit 242.

In addition, as described above, only during the unit period P1 in which the polarity indicated by the polarity signal P is positive, the second computation unit 241 generates the correction data Dh based on the second integration data DS2. That is, the second computation unit 241 does not generate the correction data Dh based on the second integration data DS2, during the unit period P2.

As illustrated FIG. 6, during the unit period P1, the second computation unit 241 updates the second integration data DS2[n] by subtracting the value obtained by doubling the value indicated by the input image data Din[n], from the second integration data DS2[n] stored in the second storage unit 242.

Specifically, the first computation unit 231 generates the second integration data DS2[1][n] to DS2[6][n] during the unit period P1. For this reason, the second integration data DS2[1][n] to DS2[6][n] can be regarded as the same as the integration values S2′ to S6′, as illustrated below.

DS2[1][n]≅S1′(=d22+d23+d24+d25+d26−d11) Equation (11)

DS2[2][n]≅S2′(=d23+d24+d25+d26−d11−d12) Equation (12)

DS2[3][n]≅S3′(=d24+d25+d26−d11−d12−d13) Equation (13)

DS2[4][n]≅S4′(=d25+d26−d11−d12−d13−d14) Equation (14)

DS2[5][n]≅S5′(=d26−d11−d12−d13−d14−d15) Equation (15)

DS2[6][n]≅S6′(=−d11−d12−d13−d14−d15−d16) Equation (16)

In this way, the value indicated by the first integration data DS1[n] generated by the second computation unit 241 during the unit period P1, can be regarded as the same as the integration value obtained by integrating the input image data Din[n] only for the unit time from the past to the present. In other words, the second integration data DS2[m][n] generated by the second computation unit 241 during the unit period P1, corresponds to the integration value obtained by integrating the image signal VD[n] only for the unit time from the past to the present.

As described above, the electro-optical device 1 according to the present embodiment performs the vertical crosstalk correction. The advantage of performing the vertical crosstalk correction will be described with reference to FIGS. 8A and 8B. In addition, it is assumed that the electro-optical device 1 is in a normally black mode in which the pixel is a black display in a state where no voltage is applied in the liquid crystal element 60, in FIGS. 8A and 8B. In addition, in FIGS. 8A and 8B, it is assumed that in order to simplify the description of the advantage of the vertical crosstalk correction, the signal generation circuit 20, without including the updating unit 26, performs the vertical crosstalk correction with respect to the input image data Din based on the correction data Dh.

If an image that is a still image in which a white window Aw (an example of an “object”) is denoted in the center of a gray background Ag is displayed without vertical crosstalk correction being performed, in the display unit 30 of the electro-optical device 1, as illustrated in FIG. 8A, the vertical crosstalk occurs as illustrated in FIG. 8B.

More specifically, as illustrated in FIG. 8B, in an upper area A1 of the window Aw, a bright color compared to gray to be originally displayed is displayed. This is because, when the image signal VDw is supplied to the pixel circuit located in the window Aw, an image signal VDa1 retained in the pixel circuit located in the upper area A1 is same polarity as the image signal VDw.

In addition, as illustrated in FIG. 8B, in a lower area A2 of the window Aw, a dark color compared to gray to be originally displayed is displayed. This is because, when the image signal VDw is supplied to the pixel circuit located in the window Aw, an image signal VDa2 retained in the pixel circuit located in the lower area A2 is opposite polarity to the image signal VDw.

Whereas, when the vertical crosstalk correction with respect to the input image data Din is performed based on the correction data Dh, as can be seen from FIGS. 5 to 7E, the first integration data DS1[n] (for example, the first integration data DS1[1][n] in FIG. 5) or the second integration data DS2[n] (for example, the second integration data DS2[1][n] in FIG. 6) which corresponds to the pixel circuit PX located in the upper area A1 of the display unit 30, denotes a positive value. Also, the first data DS1[n] (for example, the first integration data DS1[6][n] in FIG. 5) or the second integration data DS2[n] (for example, the second integration data DS2[6][n] in FIG. 6) which corresponds to the pixel circuit PX located in the lower area A2 of the display unit 30, denotes a negative value.

For this reason, the correction data Dh[n] (for example, the correction data Dh[1][n]) corresponding to the pixel circuit PX located in the upper area A1 of the display unit 30, denotes a negative value, and the correction data Dh[n] (for example, the correction data Dh[M][n]) corresponding to the pixel circuit PX located in the lower area A2 of the display unit 30, denotes a positive value.

Thus, for example, in the example illustrated in FIGS. 8A and 8B, in the pixel circuit located in the upper area A1, the image signal VDa1 which displays a darker color than gray to be originally displayed is supplied, and in the pixel circuit located in the lower area A2, the image signal VDa2 which displays a brighter color than gray to be originally displayed is supplied. As a result, the vertical crosstalk is prevented from occurring, as illustrated in FIG. 8B, and the image to be originally displayed can be displayed, as illustrated in FIG. 8A.

When, in the display unit 30, as illustrated in FIGS. 8A and 8B, the image that is the still image in which the white window Aw is denoted in the center of the gray background Ag is displayed, when the vertical crosstalk correction with respect to the input image data Din is performed based on the correction data Dh, FIGS. 9A to 9D is an explanatory diagram for explaining a relationship between a magnitude of an influence of the display gradation due to the vertical crosstalk and the correction data Dh.

FIG. 9A exemplifies a case where a still image displayed by a plurality of pixels corresponding to a plurality of pixel circuits PX located in the (n−5)th to (n+14)th columns of the mth to (m+2)th rows, includes a white window, in the center of the gray background, which is located in an area of the nth to (n+9)th columns of the (m+1)th to (m+2)th rows. That is, in FIG. 9A, the nth to (n+9)th columns of the mth row are equivalent to the upper area A1, and the nth to (n+9)th column of the (m+1)th and (m+2)th rows are equivalent to the window Aw.

FIG. 9B illustrates an amount of change ΔGc which is a difference of gradation between the gradation displayed by each pixel in the mth column and the gradation (gradation designated by the input image data Din) to be originally displayed by such pixels, when without the vertical crosstalk correction being performed, the image data Dx is generated based on the input image data Din.

As illustrated in FIG. 9B, when the vertical crosstalk correction due to the correction data Dh is not performed, a plurality of pixels located in the nth to (n+9)th columns of the mth row which is the upper area A1, are influenced by the vertical crosstalk. For this reason, the display gradation of each pixel located in the upper area A1 changes by the amount of change ΔGc. For example, when the amount of change ΔGc=“+10”, if the vertical crosstalk correction due to the correction data Dh is not performed, each pixel located in the upper area A1 displays a brighter color than that to be originally displayed by “+10”.

FIG. 9C illustrates values indicated by the correction data Dh corresponding to the plurality of pixel circuits PX located in the mth rows.

As illustrated in FIG. 9C, in order to cancel the influence of the display gradation due to the vertical crosstalk illustrated in FIG. 9B, a value of the correction data Dh corresponding to the plurality of pixel circuits PX located in the nth to (n+9)th columns of the mth row which is the upper area A1 is set to “−10”.

FIG. 9D illustrates an amount of change ΔG which is a difference of gradation between the gradation actually displayed by the plurality of pixels located in the mth row and the gradation (gradation designated by the input image data Din) to be originally displayed by such pixels, in FIG. 9A.

The gradation actually displayed by each pixel becomes a value which is obtained by adding together the gradation designated by the input image data Din, the amount of change ΔGc of the gradation which occurs when the vertical crosstalk correction is not performed, and the amount of change (amount of change of the gradation indicated by the correction data Dh) of the gradation generated by performing the vertical crosstalk correction due to the correction data Dh. Thus, the amount of change of the gradation ΔG indicates a value which is obtained by adding together the amount of change of the gradation ΔGc and the correction data Dh.

As illustrated in FIG. 9D, in each pixel located in the upper area A1, since the amount of change ΔGc is “+10” and the correction data Dh indicates “−10”, the amount of change ΔG becomes “0”. That is, as in the examples of FIGS. 9A to 9D, when the still image is displayed in the display unit 30, the vertical crosstalk correction due to the correction data Dh is performed, whereby in each pixel located in the upper area A1 (the nth to (n+9)th columns of the mth row), the gradation to be originally displayed, which is designated by the input image data Din, can be displayed.

In addition, when the image displayed in the display unit 30 is a moving image, for example, there is a case where a location of the window Aw in the image displayed in the display unit 30 moves for each unit period.

FIG. 10 illustrates an image displayed in the display unit 30 during the a different unit period, when the window Aw displayed in a location illustrated in FIGS. 8A and 8B during one unit period moves to the right in FIGS. 8A and 8B by an amount of movement Mv, during other unit period following the one unit period.

Upper areas A11 and A12 illustrated in FIG. 10 are locations which are equivalent to the upper area A1 illustrated in FIGS. 8A and 8B, and lower areas A21 and A22 illustrated in FIG. 10 are locations which are equivalent to the lower area A2 illustrated in FIGS. 8A and 8B.

In addition, it is assumed that the signal generation circuit 20 does not includes the updating unit 26 and performs the vertical crosstalk correction with respect to the input image data Din based on the correction data Dh, also in FIG. 10, in the same manner as in FIGS. 8A and 8B.

As described above, the correction data Dh for performing the vertical crosstalk correction with respect to the input image data Din supplied during the different unit period, is generated based on the input image data Din supplied during the one unit period preceding the different unit period. That is, the correction data Dh generated during the different unit period is generated on the premise that a display location of the window Aw during the different unit period, and a display location of the window Aw during one unit period preceding the different unit period are in the same location.

Thus, in the upper area A11 and the lower area A21 in FIG. 10, although the window Aw does not exist in the y direction in FIG. 10, the image signal VD[n] is supplied based on the image data Dx obtained by performing the vertical crosstalk correction in a state where the window Aw is regarded to exist in the y direction. For this reason, a so-called “over-correction” occurs, a darker color than gray to be originally displayed is displayed in the upper area A11, and a brighter color than gray to be originally displayed is displayed in the lower area A21.

In addition, in the upper area A13 and the lower area A23, although the window Aw exists in the y direction in FIG. 10, the image signal VD[n] is supplied based on the image data Dx obtained by not performing the vertical crosstalk correction in a state where the window Aw is regarded not to exist in the y direction. For this reason, the vertical crosstalk occurs in the upper area A13 and the lower area A23, a brighter color than gray to be originally displayed is displayed in the upper area A13, and a darker color than gray to be originally displayed is displayed in the lower area A23.

In addition, in the upper areas A12 and the lower area A22, in the same manner as the upper area A1 and the lower area A2 which are illustrated in FIGS. 8A and 8B, the image signal VD[n] obtained by performing the vertical crosstalk correction is supplied, and accordingly, the gray to be originally displayed is displayed.

FIGS. 11A to 11D are explanatory diagrams illustrating a relationship between the magnitude of the influence of the display gradation due to the vertical crosstalk and the correction data Dh, when an image that is a moving image in which the white window Aw is denoted in the center of the gray background Ag is displayed in the display unit 30 as illustrated in FIG. 10, and when the vertical crosstalk correction with respect to the input image data Din is performed based on the correction data Dh.

FIG. 11A exemplifies a case where the plurality of pixels corresponding to the plurality of pixel circuits PX located in (n−5)th to (n+14)th columns of mth to (m+2)th rows display the moving image. More specifically, FIG. 11A illustrates an image displayed in the display unit 30 during the different unit period, after the window Aw is displayed in a location illustrated in FIG. 9A during the one unit period preceding the different unit period, when the window Aw moves by two pixel lengths in the right direction in FIG. 11A during the different unit period following the one unit period (when amount of movement Mv=“2”).

That is, in FIG. 11A, the (n+2)th to (n+11)th columns of the (m+1)th and (m+2)th rows are equivalent to the window Aw, the nth and (n+1)th columns of the mth row are equivalent to the upper area A11, the (n+2)th to (n+9)th columns of the mth row are equivalent to the upper area A12, and the (n+10)th and (n+11)th columns of the mth row are equivalent to the upper area A13.

FIG. 11B illustrates the amount of change ΔGc of the display gradation of each pixel caused by the vertical crosstalk, when without the vertical crosstalk correction being performed, the image data Dx is generated based on the input image data Din. In addition, it is assumed that the amount of change ΔGc=“+10”, also in FIGS. 11A to 11D, in the same manner as in FIGS. 9A to 9D.

As illustrated in FIG. 11B, when the vertical crosstalk correction due to the correction data Dh is not performed, each pixel in the (n+2)th to (n+11)th columns of the mth row located in the upper area A12 or A13, are influenced by the vertical crosstalk, and the display gradation changes by the amount of change ΔGc, whereby displaying the brighter color than that to be originally displayed by “+10”.

FIG. 11C illustrates the value indicated by the correction data Dh corresponding to the plurality of pixel circuits PX located in the mth row.

The correction data Dh illustrated in FIG. 11C is generated on the premise that the location of the window Aw being displayed during the preceding unit period is not changed. For this reason, the correction data Dh is set in such a manner that the value corresponding to each pixel circuit PX in the nth to (n+9)th columns of the mth row which are located in the upper area A11 or A12 becomes “−10”.

FIG. 11D illustrates the amount of change ΔG which is the difference between the gradation actually displayed by the plurality of pixels located in the mth row and the gradation to be originally displayed by such pixels, among the amounts of movement illustrated in FIG. 11A.

As illustrated in FIG. 11D, in each pixel located in the upper area A11, the amount of change ΔGc is “0”, and the correction data Dh indicates “−10”, whereby the amount of change ΔG becomes “−10”. In addition, in each pixel located in the upper area A12, the amount of change ΔGc is “+10”, and the correction data Dh indicates “−10”, whereby the amount of change ΔG becomes “0”. In addition, in each pixel located in the upper area A13, the amount of change ΔGc is “+10”, and the correction data Dh indicates “0”, whereby the amount of change ΔG becomes “+10”.

That is, in the examples of FIGS. 11A to 11D, even when the vertical crosstalk correction due to the correction data Dh is performed, each pixel located in the upper area A11 displays a darker color than the gradation to be originally displayed by “−10”, and each pixel located in the upper area A13 displays a brighter color than the gradation to be originally displayed by “+10”.

As a result, four places of a display gradation change portion Edg occur in which the display gradation changes greatly in the horizontal direction (x direction) in FIGS. 11A to 11D (for example, the display gradation changes with a magnitude equal to or greater than 10). Then, as the result that the change of the display gradation in the x direction in the display gradation change portion Edg is visually recognized by a user of the electro-optical device 1, display quality of the electro-optical device 1 is decreased.

Whereas, the signal generation circuit 20 includes the updating unit 26, and the electro-optical device 1 according to the present embodiment performs the vertical crosstalk correction with respect to the input image data Din based on the updated correction data Dk obtained by modifying the correction data Dh. As a result, even when the image displayed by the display unit 30 is a moving image, compared to when the vertical crosstalk coercion is performed based on the correction data Dh without the updating unit 26 being included, the number of display gradation change portions Edg occurring in the center of the display image is decreased, and the display quality of the moving image can be improved.

Hereinafter, specifically, a relationship between the gradation displayed by each pixel installed in the display unit 30 of the electro-optical device 1 according to the present embodiment, and the updated correction data Dk will be described.

FIGS. 12A to 12D are explanatory diagrams illustrating a relationship between the magnitude of the influence on the display gradation due to the vertical crosstalk and the updated correction data Dk, when the same moving image (that is, a moving image in which the white window Aw is denoted in the center of the gray background Ag) as that in FIGS. 11A to 11D are displayed in the display unit 30, and when the vertical crosstalk correction corresponding to the input image data Din is performed based on the updated correction data Dk.

FIG. 12A exemplifies a case where a plurality of pixels corresponding to the plurality of pixel circuits PX located in (n−5)th to (n+14)th columns of the mth to (m+2)th rows display the same moving image as that in FIG. 11A. More specifically, FIG. 12A illustrates the image displayed in the display unit 30 during the different unit period, after the window Aw is displayed in the location illustrated in FIG. 9A during the preceding one unit period, when the window Aw moves by two pixels in the right direction in FIG. 12A during the different unit period following the one unit period (when the amount of movement Mv=“2”).

That is, in FIG. 12A, the (n+2)th to (n+11)th columns of the (m+1)th and (m+2)th rows are equivalent to the window Aw, the nth and (n+1)th columns of the mth row the upper area A11, the (n+2)th to (n+9)th columns of the mth row the upper area A12, and the (n+10)th and (n+11)th columns of the mth row the upper area A13.

FIG. 12B illustrates the amount of change ΔGc of the display gradation of each pixel caused by the vertical crosstalk, without the vertical crosstalk correction being performed, when the image data Dx is generated based on the input image data Din. In addition, it is assumed that the amount of change ΔGc=“+10”, also in FIGS. 12A to 12D, in the same manner as in FIGS. 9A to 9D and 11A to 11D.

As illustrated in FIG. 12B, when the vertical crosstalk correction is not performed, in the same manner as in FIG. 11B, each pixel located in the upper area A12 or A13 is influenced by the vertical crosstalk, changes the display gradation by the amount of change ΔGc, and displays a brighter color than the color to be originally displayed by “+10”.

FIG. 12C illustrates a value indicated by the updated correction data Dk corresponding to the plurality of pixel circuits PX located in the mth row. The updated correction data Dk illustrated in FIG. 12C is data generated by modifying the correction data Dh which is illustrated in FIG. 11C and generated by the generation unit 22, in the updating unit 26.

More specifically, when the display unit 30 displays the moving image illustrated in FIG. 12A, and the specification unit 25 specifies the pixel circuits PX[m][n−1] located in the (n−1)th column and the pixel circuits PX[m][n] located in the nth column, among the pixel circuits PX in the mth row illustrated in FIG. 12A, as the boundary pixel circuit, and also specifies the pixel circuits PX[m][n+9] located in the (n+9)th column and the pixel circuits PX[m][n+10] located in the (n+10)th column, as the boundary pixel circuit.

In addition, when the display unit 30 displays the moving image illustrated in FIG. 12A, the updating unit 26 specifies the pixel circuits PX[m][n−4] to PX[m][n+3] as the target pixel circuit, and also specifies the pixel circuits PX[m][n+6] to PX[m][n+13] as the target pixel circuit.

Then, among the pixel circuits PX[m][n−4] to PX[m][n+3] which are target pixel circuits, the updating unit 26 generates the updated correction data Dk[m][n−4] to Dk[m][n−1] by subtracting the modified value C1 from the correction data Dh[m][n−4] to Dh[m][n−1] corresponding to the pixel circuits PX[m][n−4] to PX[m][n−1] which are the left target pixel circuit PXL, and generates the updated correction data Dk[m][n] to Dk[m][n+3] by adding the modified value C2 to the correction data Dh[m][n] to Dh[m][n+3] corresponding to the pixel circuits PX[m][n] to PX[m][n+3] which are the right target pixel circuit PXR.

In addition, the updating unit 26 generates the updated correction data Dk[m][n+6] to Dk[m][n+9] by adding the modified value C1 to the correction data Dh[m][n+6] to Dh[m][n+9], and generates the updated correction data Dk[m][n+10] to Dk[m][n+13] by subtracting the modified value C2 from the correction data Dh[m][n+10] to Dh[m][n+13].

In addition, the updating unit 26 sets the correction data Dh with respect to the pixel circuits besides the target pixel circuits as the updated correction data Dk.

In addition, hereinafter, it is assumed that the modified values C1 and C2 are “3”. That is, a value indicated by each of the correction data Dh[m][n−4] to Dh[m][n−1] becomes “0”, a value indicated by each of the updated correction data Dk[m][n−4] to Dk[m][n−1] becomes “−3”, with respect to which a value indicated by each of the correction data Dh[m][n] to Dh[m][n+3] is “−10”, and a value indicated by each of the updated correction data Dk[m][n] to Dk[m][n+3] becomes “−7”. In addition, a value indicated by each of the updated correction data Dk[m][n+6] to Dk[m][n+9] becomes “−7”, and a value indicated by each of the updated correction data Dk[m][n+10] to Dk[m][n+13] becomes “−3”.

FIG. 12D illustrates the amount of change ΔG which is the difference between the gradation actually displayed by the plurality of pixels located in the mth row and the gradation to be originally displayed by such pixels, in FIG. 12A. In FIGS. 12A to 12D, the amount of change ΔG of the gradation illustrates a value obtained by adding together the amount of change ΔGc of the gradation and the updated correction data Dk.

In the example illustrated in FIG. 12D, the display gradation change portion Edg in which the display gradation changes greatly (for example, equal to or greater than 10) in the horizontal direction (x direction) is 2 places. Thus, in the example illustrated in FIGS. 12A to 12D, as compared to the example illustrated in FIGS. 11A to 11D, the number of display gradation change portions Edg occurring in the center of the display image is decreased, and the display quality of the moving image is improved.

As described above, the electro-optical device 1 according to the present embodiment modifies the correction data Dh generated by the generation unit 22 in the updating unit 26, and performs the vertical crosstalk correction with respect to the input image data Din based on the updated correction data Dk which is the modified correction data Dh.

For this reason, the electro-optical device 1 according to the present embodiment can decrease the number of display gradation change portions Edg occurred when the moving image is displayed in the display unit 30, compared to when the vertical crosstalk correction with respect to the input image data Din is performed based on the correction data Dh. As a result, the display quality of the moving image can be improved.

### B. Second Embodiment

In the first embodiment, the predetermined number Z which is the number of pixel circuits PX configuring the target pixel circuit, the value W1 which is the number of pixel circuits PX configuring the left target pixel circuits PXL, and the value W2 which is the number of pixel circuits PX configuring the right target pixel circuits PXR are values determined in advance.

Whereas, the electro-optical device according to the second embodiment is different from the electro-optical device 1 according to the first embodiment, in a point where the predetermined number Z, the value W1 and the value W2 are determined based on the amount of movement Mv in the extending direction of the scan line 32 of the object denoted by the image displayed in the display unit. Hereinafter, the electro-optical device according to the second embodiment will be described with reference to FIGS. 13 and 14A to 14D.

The electro-optical device according to the second embodiment is configured in the same manner as the electro-optical device 1 according to the first embodiment, except that a signal generation circuit 20a illustrated in FIG. 13 is included therein, instead of the signal generation circuit 20 illustrated in FIG. 3. The signal generation circuit 20a illustrated in FIG. 13 is configured in the same manner as the signal generation circuit 20 illustrated in FIG. 3, except that the detection unit 28 which detects the amount of movement Mv of the object is included therein and an updating unit 26a is included therein instead of the updating unit 26. The updating unit 26a is configured in the same manner as the updating unit 26, except for determining the predetermined number Z based on the amount of movement Mv.

Hereinafter, in the electro-optical device according to the second embodiment, with regard to the same operation or function as that of the first embodiment, each of the detailed descriptions will be appropriately omitted using the symbols referenced in the first embodiment (the same is applied to each form exemplified below).

As illustrated in FIG. 13, the signal generation circuit 20a included in the electro-optical device according to the second embodiment includes a detection unit 28 that detects the amount of movement Mv of the object denoted in the center of the image displayed in the display unit 30.

Here, the object is a figure or the like denoted in the center of the image displayed in the display unit 30, for example, the window Aw or the like illustrated in FIG. 10 or the like is equivalent to the object.

In addition, the amount of movement Mv is a movement distance during the unit time with respect to the extending direction (x direction) of the scan line 32 of the object, when the location of the object denoted in the center of the image displayed in the display unit 30 moves. Specifically, the amount of movement Mv is a value that denotes the number of pixels of the object which move in the x direction (or −x direction) during the unit period.

In the present embodiment, the detection unit 28 detects the amount of movement Mv of the object based on the input image data Din. More specifically, the detection unit 28 detects the amount of movement Mv of the object, by comparing the input image data Din supplied during the one unit period, and the input image data Din supplied during the different unit period following the one unit period.

In addition, instead of detection of the amount of movement Mv of the object based on the input image data Din, the detection unit 28 may detect the amount of movement Mv of the object based on information denoting a location of the boundary pixel circuit specified by the specification unit 25. For example, the detection unit 28 may detect the amount of movement Mv of the object, by comparing the location of the boundary pixel circuit specified by the specification unit 25 during the one unit period, and the location of the boundary pixel circuit specified by the specification unit 25 during the different unit period following the one unit period.

The detection unit 28 supplies the updating unit 26a with the amount of movement Mv of the object which is detected. The updating unit 26a specifies the target pixel circuit by determining the predetermined number Z based on the amount of movement Mv. More specifically, the updating unit 26a sets the values W1 and W2 as the same value as the amount of movement Mv. As a result, the updating unit 26a specifies the target pixel circuit formed from the left target pixel circuits PXL with the same numbers as the amount of movement Mv, and the right target pixel circuits PXR with the same numbers as the amount of movement Mv.

FIGS. 14A to 14D are explanatory diagrams illustrating a relationship between the magnitude of the influence on the display gradation due to the vertical crosstalk and the updated correction data Dk, when the same moving image (that is, the moving image in which the white window Aw is denoted in the center of the gray background Ag) as that in FIGS. 12A to 12D is displayed in the display unit 30, and when the vertical crosstalk correction corresponding to the input image data Din is performed based on the updated correction data Dk.

FIG. 14A exemplifies a case where a plurality of pixels PX corresponding to the plurality of pixel circuits PX located in (n−5)th to (n+14)th columns of the mth to (m+2)th rows display the same moving image as that in FIG. 12A. That is, FIGS. 14A to 14D exemplify cases where the amount of movement My of the window Aw which is the object is “2”, in the same manner as the example illustrated in FIGS. 12A to 12D.

FIG. 14B illustrates the amount of change ΔGc of the display gradation of each pixel caused by the vertical crosstalk, without the vertical crosstalk correction being performed, when the image data Dx is generated based on the input image data Din. In addition, it is assumed that the amount of change ΔGc=“+10”, also in FIGS. 14A to 14D, in the same manner as in FIGS. 12A to 12D.

FIG. 14C illustrates a value indicated by the updated correction data Dk corresponding to the plurality of pixel circuits PX located in the mth row. The updated correction data Dk illustrated in FIG. 14C is data generated by modifying the correction data Dh which is illustrated in FIG. 11C and generated by the generation unit 22, in the updating unit 26a.

More specifically, when the moving image illustrated in FIG. 14A is displayed in the display unit 30, and the specification unit 25 specifies the pixel circuits PX[m][n−1] located in the (n−1)th column and the pixel circuits PX[m][n] located in the nth column, among the pixel circuits PX in the mth row, as the boundary pixel circuit, the updating unit 26a specifies two pixel circuits PX[m][n−2] and PX[m][n−1] which are the same numbers as the amount of movement Mv, as the left target pixel circuits PXL, and specifies two pixel circuits PX[m][n] and PX[m][n+1] which are the same numbers as the amount of movement Mv, as the right target pixel circuits PXR, whereby specifying the target pixel circuits. Then, the updating unit 26a generates the updated correction data Dk by modifying the correction data Dh corresponding to the target pixel circuits.

In addition, it is assumed that the modified values C1 and C2 are “3”, in the example illustrated in FIGS. 14A to 14D, in the same manner as in FIGS. 12A to 12D. That is, a value indicated by each of the updated correction data Dk[m][n−2] and Dk[m][n−1] becomes “−3”, and a value indicated by each of the updated correction data Dk[m][n] and Dk[m][n+1] becomes “−7”.

FIG. 14D illustrates the amount of change ΔG which is the difference between the gradation actually displayed by the plurality of pixels located in the mth row and the gradation to be originally displayed by such pixels, among the amounts of movement illustrated in FIG. 14A.

In the example illustrated in FIG. 14D, the display gradation change portion Edg where the display gradation changes greatly (for example, equal to or greater than 10) in the x direction does not exist. That is, the electro-optical device according to the present embodiment can prevent the display gradation change portion Edg from occurring, and the display quality of the moving image can be improved, compared to the electro-optical device 1 according to the first embodiment.

### C. Modification Example

Each of the above-described forms can be modified in various ways. Aspects of specific modification will be exemplified below. Aspects, which are arbitrarily selected from the following examples, equal to or more than two can be appropriately combined to the extent not inconsistent with each other.

### Modification Example 1

In the above-described embodiments, the modified values C1 and C2 are the same value as each other, but may be different to each other.

### Modification Example 2

In the above-described embodiments and modification example, the target pixel circuit is divided into two pieces of the left target pixel circuits PXL and the right target pixel circuit PXR, thereby a subtraction value obtained by subtracting the value indicated by the updated correction data Dk corresponding to the target pixel circuit from the value indicated by the correction data Dh corresponding to the target pixel circuit, generates the updated correction data Dk so as to be 2 values. But the invention is not limited to such an aspect, and may generate the updated correction data Dk in such a manner that the subtraction value becomes 1 value. In addition, the updated correction data Dk may be generated in such a manner that the subtraction value becomes a value equal to or greater than 3 values.

Specifically, for example, in the example illustrated in FIGS. 12A to 12D, the subtraction value obtained by subtracting the updated correction data Dk from the correction data Dh corresponding to the target pixel circuit is 2 value of “−3” and “−7”, but the updated correction data Dk may be generated in such a manner that the subtraction value becomes 4 value of “−2”, “−4”, “−6” and “−8”. At this time, the change of the gradation around the boundary pixel circuit can gradually occur, and the possibility of occurrence of the display gradation change portion Edg can be decreased.

### Modification Example 3

In the above-described embodiments and modification examples, the updating unit 26 (or, updating unit 26a) determines the predetermined number Z of pieces of updated correction data Dk corresponding to the predetermined number Z of the pixel circuits PX which configure the target pixel circuit, based on the predetermined number Z of pieces of correction data Dh corresponding to the predetermined number Z of the pixel circuits PX which configure the target pixel circuit. But the invention is not limited to such an aspect, and may generate the updated correction data Dk of the predetermined number Z, based on the two pieces of correction data Dh corresponding to the two pixel circuits PX which configure the boundary pixel circuit.

For example, when the pixel circuits PX[m][n−1] and PX[m][n] are specified as the boundary pixel circuit, and the target pixel circuit including such a boundary pixel circuit is specified, all of the W1 pieces of the updated correction data Dk corresponding to the W1 pieces of the pixel circuits PX configuring the left target pixel circuit PXL may be set as a value obtained by adding or subtracting the modified value C1 to or from the value indicated by the correction data Dh[m][n−1]. Also, all of the W2 pieces of the updated correction data Dk corresponding to the W2 pieces of the pixel circuits PX configuring the right target pixel circuit PXR may be set as a value obtained by adding or subtracting the modified value C2 to or from the value indicated by the correction data Dh[m][n].

FIG. 18 is an explanatory diagram for explaining by comparing a generation method (hereinafter, there is a case of being referred to as “method B”) of the updated correction data Dk according to the present modification example with a generation method (hereinafter, there is a case of being referred to as “method A”) of the updated correction data Dk according to the above-described embodiments (for example, the first embodiment). In FIG. 18, when eight pieces of pixel circuits PX of the pixel circuits PX[m][n−4] to PX[m][n+3] are the target pixel circuit, and the pixel circuits PX[m][n−1] to PX[m][n] are the boundary pixel circuit, that is, in the same manner as in FIGS. 12A to 12D, when four pieces of pixel circuits PX of the pixel circuits PX[m][n−4] to PX[m][n−1] are the left target pixel circuit PXL, and four pieces of pixel circuits PX of the pixel circuits PX[m][n] to PX[m][n+3] are the right target pixel circuit PXR, a value indicated by eight pieces of the correction data Dh (illustrated by “◯” in FIG. 18) corresponding to the eight pieces of the pixel circuits PX configuring the such target pixel circuits, and eight pieces of the updated correction data Dk (illustrated “” by in FIG. 18), is denoted. More specifically, in each of the six graphs illustrated in FIG. 18, a horizontal axis denotes number of column (in this column, (n−4)th to (n+3)th columns) in which each pixel circuit PX is arranged, and a vertical axis denotes a value indicated by the correction data Dh and the updated correction data Dk which correspond to each pixel circuit PX.

Example 1 of FIG. 18, in the same manner as in FIGS. 11A to 11D, illustrates a case where four values indicated by four pieces of the correction data Dh corresponding to the left target pixel circuit PXL are as the same as the value indicated by the correction data Dh[m][n−1], and four values indicated by four pieces of the correction data Dh corresponding to the right target pixel circuit PXR are as the same as the value indicated by the correction data Dh[m][n]. In a case of the example 1, although any method of the method A and the method B is used, four values indicated by four pieces of the updated correction data Dk corresponding to the left target pixel circuit PXL become equal to a value obtained by subtracting the modified value C1 from the correction data Dh[m][n−1], and four values indicated by four pieces of the updated correction data Dk corresponding to the right target pixel circuit PXR become equal to a value obtained by adding the modified value C2 from the correction data Dh[m][n].

Examples 2 and 3 of FIG. 18, other than the examples illustrated in FIGS. 11A to 11D, illustrate a case where eight values indicated by eight pieces of correction data Dh corresponding to the target pixel circuit are different from one another. At this time, according to the method A, four values indicated by four pieces of the updated correction data Dk corresponding to the left target pixel circuit PXL (or, the right target pixel circuit PXR) become the value (or, the value obtained by adding the modified value C2) obtained by subtracting the modified value C1 from the value indicated by the corresponding correction data Dh. That is, in a case of the examples 2 and 3, according to the method A, the four values indicated by the four pieces of the updated correction data Dk corresponding to the left target pixel circuit PXL (or, the right target pixel circuit PXR) become a value different from one another.

On the other hand, according to the method B with respect to the present modification example, all of the four values indicated by four pieces of the updated correction data Dk corresponding to the left target pixel circuit PXL (or, the right target pixel circuit PXR) can be a value the same as the value (or, the value obtained by adding the modified value C2 to the correction data Dh[m][n]) obtained by subtracting the modified value C1 from the correction data Dh[m][n−1]. As a result, the value indicated by updated correction data Dk corresponding to the target pixel circuit can be standardized, and particularly, in a case of the example two, a value indicated by two pieces of the updated correction data Dk corresponding to two pixel circuits PX adjacent to each other can decrease occurrence of the display gradation change portion Edg which occurs due to a significant difference.

In addition, the generation method B of the updated correction data Dk illustrated in FIG. 18 is merely an example in which the updated correction data Dk corresponding to the target pixel circuit is generated based on the two pieces of the correction data Dh corresponding to the two pixel circuits PX which configure the boundary pixel circuit. For example, all of the predetermined number Z of pieces of updated correction data Dk corresponding to the predetermined number Z of the pixel circuits PX which configure the target pixel circuit may be one value between the value indicated by the correction data Dh[m][n−1] and the value indicated by the correction data Dh[m][n]. In short, if the value indicated by the updated correction data Dk corresponding to the target pixel circuit is determined to be greater than the smaller value and to be smaller than the greater value, between the two values indicated by the two pieces of the correction data Dh corresponding to the two pixel circuits PX which configure the boundary pixel circuit, the updated correction data Dk may be generated by such a method.

### Modification Example 4

In the above-described embodiments and modification examples, the predetermined number Z of the target pixel circuit includes the W1 pieces of the left target pixel circuits PXL and the W2 pieces of the right target pixel circuits PXR, the values W1 and W2 are positive values which are the same as each other, but the invention is not limited to such an aspect, and the values W1 and W2 may be different to each other. In addition, one of the values W1 and W2 may be “0”. At this time, the predetermined number Z may be an integer equal to or greater than “1”.

For example, when the value W2 becomes “0”, the target pixel circuit is configured only from the left target pixel circuit PXL. At this time, when the value W1 becomes “1”, the target pixel circuit is configured only from one (for example, left in FIG. 1 or the like) pixel circuit PX of the two pixel circuits PX which configure the boundary pixel circuit. When the value W1 becomes “0”, the target pixel circuit is configured only from the right target pixel circuit PXR. At this time, when the value W2 becomes “1”, the target pixel circuit is configured only from the other (for example, right in FIG. 1 or the like) pixel circuit PX of the two pixel circuits PX which configure the boundary pixel circuit.

In this way, the target pixel circuit may include at least one pixel circuit PX of the two pixel circuits PX which configure the boundary pixel circuit.

In addition, when one of the values W1 and W2 becomes “0”, based on the value indicated by the two pieces of correction data Dh corresponding to the two pixel circuits PX which configure the boundary pixel circuit, the determination of whether one of the values W1 and W2 becomes “0” may be performed. For example, between the two pixel circuits PX which configure the boundary pixel circuit, the values W1 and W2 may be determined, in such a manner that the target pixel circuit exists only in the direction in which the pixel circuit PX, which is viewed from the boundary, with a greater absolute value of the values indicated by the correction data Dh is located.

### Modification Example 5

In the above-described embodiments and modification examples, the generation unit 22 includes the first generation unit 23 which outputs the correction data Dh during the unit period P2, and the second generation unit 24 which outputs the correction data Dh during the unit period P1. But the invention is not limited to such an aspect, and the generation unit 22 may include one of the first generation unit 23 and the second generation unit 24.

For example, when the generation unit 22 includes only the first generation unit 23 without the second generation unit 24, the generation unit 22 does not output the correction data Dh during the unit period P1, but outputs the correction data Dh only during the unit period P2. Thus, at this time, the correction unit 27 does not perform the vertical crosstalk correction with respect to the input image data Din during the unit period P1, but may perform the vertical crosstalk correction with respect to the input image data Din only during the unit period P2.

In addition, at this time, since the influence due to the vertical crosstalk occurs and a gradation which is different from the gradation to be originally displayed is displayed, in the image displayed in the display unit 30 during the unit period P1, it is preferable that a stronger vertical crosstalk correction than the above-described embodiments and modification examples be performed, during the unit period P2. That is, at this time, it is preferable that the generation unit 22 generate the correction data Dh in which the absolute value of the value indicated by the correction data Dh which is generated during the unit period P2, becomes the greater value than the absolute value of the value indicated by the correction data Dh in the above-described embodiments and modification examples.

In addition, at this time, the first generation unit 23 may include two storage units, instead of one piece of the first storage unit 232. When the first generation unit 23 includes two storage units, one storage unit of the two storage units may store the integration value of the input image data Din supplied during the unit period P1 in each column, and the other storage unit may store the integration value of the input image data Din supplied during the unit period P2 in each column. Then, when the first generation unit 23 includes two storage units, the first computation unit 231 may generate the correction data Dh, during the unit period P2, based on two integration values stored in the two storage units.

### Modification Example 6

In the above-described embodiments and modification examples, when the correction data Dh[n] is generated during the one unit period, the generation unit 22 generates the correction data Dh[n], by integrating the input image data Din[n] supplied from the start of the one unit period to the present, with the input image data Din[n] supplied from the start of the different unit period preceding the one unit period to the end. But the invention is not limited to such an aspect, and the generation unit 22 may generate the correction data Dh[n], at least based on the input image data Din[n] supplied only for the unit time from the past to the present. At this time, for example, in the first generation unit 23, the first storage unit 232 may store M pieces of input image data Din[1][n] to Din[M][n] supplied only for at least the unit time from the past to the present, and the first computation unit 231 may generate the first integration data DS1[m][n] by integrating the M pieces of input image data Din stored in the first storage unit 232, and may generate the correction data Dh[m][n] based on the first integration data DS1[m][n].

### D. Application Example

The electro-optical device 1 exemplified in each form described above can be used in various electronic apparatuses. In FIGS. 15 to 17, a specific form of the electronic apparatus which employs the electro-optical device 1 is exemplified.

FIG. 15 is a perspective view of a projection type display apparatus (three-plate type projector) 4000 in which the electro-optical device 1 is employed. The projection type display apparatus 4000 is configured to include three electro-optical devices 1 (10R, 10G, 10B) corresponding to display colors (red, green, blue) different to one another. An illumination optical system 4001 supplies the electro-optical device 10R with red component r of light emitted from an illumination device (light source) 4002, the electro-optical device 10G with green component g, and the electro-optical device 10B with blue component b. Each electro-optical device 1 functions as a light modulator (light bulb) which modulates each monochromatic light supplied from the illumination optical system 4001 in response to the display image. A projection optical system 4003 combines the light emitted from each electro-optical device 1 and emits the combined light on a projection surface 4004. An observer visually recognizes an image projected on the projection surface 4004.

FIG. 16 is a perspective view of a portable personal computer which employs the electro-optical device 1. The personal computer 2000 includes the electro-optical device 1 which displays various images, and a body portion 2010 in which a power supply switch 2001 and a keyboard 2002 are installed.

FIG. 17 is a perspective view of a cellular phone which employs the electro-optical device 1. The cellular phone 3000 includes a plurality of manipulation buttons 3001 and scroll buttons 3002, and the electro-optical device 1 which displays various images. Depending on a manipulation of the scroll buttons 3002, a screen which is displayed in the electro-optical device 1 is scrolled.

In addition, as the electronic apparatus to which the electro-optical device according to the embodiment of the invention is applied, in addition to the apparatuses exemplified in FIGS. 15 to 17, there is an apparatus or the like which includes a Personal Digital Assistants (PDA), a digital still camera, a television, a video camera, a car-navigation device, an indicator for a vehicle (instrument panel), an electronic organizer, an electronic paper, an electronic calculator, a word processor, a workstation, a videophone, a POS terminal, a printer, a scanner, a copier, a video player, or a touch panel.

This application claims priority to Japan Patent Application No. 2013-050654 filed Mar. 13, 2013, the entire disclosures of which are hereby incorporated by reference in their entireties.

What is claimed is:

1. A display control circuit that is provided in an electro-optical device which includes a scan line; a plurality of data lines that include a first data line and a second data line adjacent to the first data line; a plurality of pixel circuits that include a first pixel circuit installed so as to correspond to the scan line and the first data line, and a second pixel circuit installed so as to correspond to the scan line and the second data line; and a driving unit that, when image data is supplied, supplies an image signal generated based on the image data, through the data line, to a pixel circuit installed so as to correspond to the data line, the display control circuit supplying the driving unit with the image data, the display control circuit comprising:
a generation unit that, based on input image data supplied only for a unit time from the past to the present, generates a plurality of pieces of correction data which include a first correction data corresponding to an integration value which is obtained by integrating a voltage of the image signal supplied to the first data line only for the unit time from the past to the present, and a second correction data corresponding to an integration value which is obtained by integrating the voltage of the image signal supplied to the second data line only for the unit time from the past to the present;
an updating unit that, when a correction difference value which denotes a difference between the first correction data and the second correction data is equal to or greater than a predetermined threshold, updates the plurality of pieces of correction data by modifying at least one value of a value indicated by the first correction data and a value indicated by the second correction data so as to be a value between the value indicated by the first correction data and the value indicated by the second correction data; and
a correction unit that, based on the updated correction data which is updated by the updating unit, generates the image data by correcting the present input image data and supplies the driving unit with the generated image data.

2. A display control circuit that is provided in an electro-optical device which includes a scan line; a plurality of data lines; a plurality of pixel circuits installed so as to correspond to an intersection between the scan line and the plurality of data lines; and a driving unit that, when image data is supplied, supplies an image signal generated based on the image data, through the data line, to a pixel circuit installed so as to correspond to the data line, the display control circuit supplying the driving unit with the image data, the display control circuit comprising:
a generation unit that, based on input image data supplied only for the unit time from the past to the present, generates correction data corresponding to an integration value which is obtained by integrating a voltage of the image signal supplied to each data line only for the unit time from the past to the present, so as to correspond to each of the plurality of pixel circuits;
a specification unit that, when a correction difference value which denotes a difference between two pieces of correction data corresponding to two pixel circuits adjacent to each other in an extending direction of the scan line among the plurality of pixel circuits, is equal to or greater than a predetermined threshold, specifies the two pixel circuits as a boundary pixel circuit;
an updating unit that includes at least one of the two pixel circuits which configure the boundary pixel circuit among the plurality of pixel circuits, specifies a predetermined number of pixel circuits which are consecutively installed in the extending direction of the scan line, modifies a value indicated by each of the predetermined number of pieces of correction data corresponding to the specified predetermined number of pixel circuits so as to be a value between two values indicated by two pieces of correction data corresponding to the two pixel circuits which configure the boundary pixel circuit, and thereby updating the plurality of pieces of correction data; and
a correction unit that, based on the updated correction data which is updated by the updating unit, generates the image data by correcting the present input image data and supplies the driving unit with the generated image data.

3. The display control circuit according to claim 2,
wherein the predetermined number of pixel circuits include both of the two pixel circuits which configure the boundary pixel circuit, and
wherein the updating unit specifies the predetermined number of pixel circuits in such a manner that the number of pixel circuits installed in the other pixel circuit side of the two pixel circuits viewed from one pixel circuit of the two pixel circuits which configure the boundary pixel circuit among the predetermined number of pixel circuits, becomes equal to the number of pixel circuits installed in the one pixel circuit side viewed from the other pixel circuit among the predetermined number of pixel circuits.

4. The display control circuit according to claim 2, wherein the updating unit updates the plurality of pieces of correction data, in such a manner that the value indicated by each of the predetermined number of pieces of updated correction data corresponding to the predetermined number of pixel circuits becomes equal values to each other.

5. The display control circuit according to claim 2,
wherein the updating unit specifies the predetermined number of pixel circuits, so as to include both of the two pixel circuits which configure the boundary pixel circuit, and
wherein the updating unit updates the plurality of pieces of correction data, in such a manner that the value indicated by the updated correction data corresponding to the pixel circuit installed in the other pixel circuit side of the two pixel circuits viewed from the one pixel circuit of the two pixel circuits which configure the boundary pixel circuit, among the predetermined number of pixel circuits, becomes the value between the value indicated by the updated correction data corresponding to the pixel circuit installed in the one pixel circuit side viewed from the other pixel circuit, among the predetermined number of pixel circuits, and the value indicated by the correction data before being updated which corresponds to the other pixel circuit.

6. The display control circuit according to claim 2, further comprising:
a detection unit that detects an amount of movement of a predetermined object denoted in the center of an image displayed by the electro-optical device in the extending direction of the scan line during the unit time, and
wherein the updating unit determines the predetermined number of pixel circuits in response to the amount of movement.

7. The display control circuit according to claim 6,
wherein the amount of movement is the number of pixels of the image which move during the unit time, and
wherein the updating unit updates the predetermined number of pixel circuits, in such a manner that one or both of the number of pixel circuits installed in the other pixel circuit side of the two pixel circuits viewed from the one pixel circuit of the two pixel circuits which configure the boundary pixel circuit, among the predetermined number of pixel circuits, and the number of pixel circuits installed in the one pixel circuit side viewed from the other pixel circuit, among the predetermined number of pixel circuits, becomes equal to the amount of movement.

8. An electro-optical device, comprising:
a display control circuit according to claim 1;
a scan line;
a plurality of data lines;
a plurality of pixel circuits that are installed so as to correspond to an intersection between the scan line and the plurality of data lines; and
a driving unit that, when image data is supplied, supplies an image signal generated based on the image data, through the data line, to the pixel circuits installed so as to correspond to the data line.

9. An electro-optical device, comprising:
a display control circuit according to claim 2;
a scan line;
a plurality of data lines;
a plurality of pixel circuits that are installed so as to correspond to an intersection between the scan line and the plurality of data lines; and
a driving unit that, when image data is supplied, supplies an image signal generated based on the image data, through the data line, to the pixel circuits installed so as to correspond to the data line.

10. The electro-optical device according to claim 8,
wherein the driving unit generates the image signal so as to invert a polarity of the signal with a reference level serving as a center during a predetermined period, and
wherein the generation unit generates correction data corresponding to the pixel circuits installed so as to correspond to one data line, based on an integration value obtained by performing one of addition and subtraction, in response to the polarity, of the input image data corresponding to the one data line, among the input image data supplied only for the unit time from the past to the present.

11. The electro-optical device according to claim 9,
wherein the driving unit generates the image signal so as to invert a polarity of the signal with a reference level serving as a center during a predetermined period, and
wherein the generation unit generates correction data corresponding to the pixel circuits installed so as to correspond to one data line, based on an integration value obtained by performing one of addition and subtraction, in response to the polarity, of the input image data corresponding to the one data line, among the input image data supplied only for the unit time from the past to the present.

12. An electronic apparatus, comprising:
the electro-optical device according to claim 8.
